(19) United States
(12) Patent Application Publication
(10) Pub. No.: US 2008/0145710 A1
(43) Pub. Date: Jun. 19, 2008

(54) MAGNETIC RECORDING MEDIUM

(75) Inventors: Takayoshi KUWAJIMA, Tokyo (JP); Katsuhiko Yamazaki, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TDK Corporation, Tokyo (JP)

(21) Appl. No.: 11/958,036

(22) Filed: Dec. 17, 2007

(30) Foreign Application Priority Data
Dec. 19, 2006 (JP) 2006-340797

(51) Int. Cl. G11B 5/66

(52) U.S. Cl. 428/831

(57) ABSTRACT

The present invention provides a high-capacity magnetic recording medium which has a thinned back coat layer excellent in surface smoothness and durability and is excellent in electromagnetic conversion property. A magnetic recording medium comprising at least a non-magnetic support, a lower non-magnetic layer on one surface of the non-magnetic support, an upper magnetic layer on the lower non-magnetic layer, and a back coat layer on the other surface of the non-magnetic support, wherein the lower non-magnetic layer contains at least carbon black, a non-magnetic inorganic powder other than carbon black, and a binder resin material, the upper magnetic layer contains at least a ferromagnetic powder, and a binder resin material, and the back coat layer contains at least carbon black, a non-magnetic inorganic powder other than carbon black, a phosphate amine salt, and nitrocellulose resin as a binder resin material, and has a thickness of 0.3 to 0.8 μm.

### BACKGROUND OF THE INVENTION

1. Field of the Invention

The present invention relates to a magnetic recording medium, more specifically, to a high-capacity magnetic recording medium which has a thinned back coat layer excellent in surface smoothness and durability and is excellent in electromagnetic conversion property.

2. Disclosure of the Related Art

Conventionally, magnetic recording media have a magnetic layer on one surface of a non-magnetic support, and have a back coat layer on the other surface of the non-magnetic support in order to improve the running durability thereof and others.

In recent years, the recording density of magnetic recording medium has been desired to be made high in order to cope with an increase in the quantity of recording data. In order to make the recording density of the medium higher, the recording wavelength thereof has been made shorter and the magnetic layer has been made thinner. As the recording wavelength is made shorter, the magnetic layer surface is required to be made smoother from the viewpoint of spacing loss.

In the case that the magnetic layer is made thin, the surface roughness of the support is reflected on the surface of the magnetic layer so that the smoothness of the magnetic layer surface is damaged. Consequently, the electromagnetic conversion property of the magnetic layer deteriorates. For this reason, a non-magnetic layer is formed as an undercoat layer on the surface of the support, and then the magnetic layer is formed on this non-magnetic layer.

Japanese Laid-Open Patent Publication No. 2001-344737 discloses that, about a magnetic recording medium, anon-magnetic layer contains carbon black treated with at least one kind of anionic surfactant selected from carboxylic acid amine salts and phosphate amine salts.

Japanese Laid-Open Patent Publication No. 2002-312922 discloses that, about a magnetic recording medium, a magnetic layer contains ferromagnetic powder treated with at least one kind of anionic surfactant selected from carboxylic acid amine salts and phosphate amine salts.

### SUMMARY OF THE INVENTION

With a rise in the capacity of magnetic recording media in recent years, it is necessary to make the total thickness of a magnetic tape small in order to make the length of the tape contained per roll large. It is therefore necessary to make the above-mentioned magnetic layer thin; in addition thereto, it is necessary to make the non-magnetic support of the tape thin by use of a resin film made of polyethylene naphthalate (PEN), polyamide (PA), polyimide (PI), polyamideimide (PAI), or the like as the non-magnetic support, and further make individual layers in the tape, such as a non-magnetic layer and a back coat layer, thin.

In the meantime, in order to maintain the surface smoothness of the magnetic layer, it is necessary to heighten the running durability of the back coat layer surface to maintain the smoothness of said surface which is in contact with the magnetic layer surface in the state that the tape is wounded.

In short, as for the back coat layer, said layer is required to be made thin and simultaneously the surface smoothness and the running durability thereof are required to be improved.

However, if the back coat layer is only made thin, projections made of a pigment on the rear face of the non-magnetic support may stick out from the surface of the thinned back coat layer. Alternatively, the projections on the rear face of the non-magnetic support make the surface of the thinned back coat layer coarse even if the projections do not stick out from the surface of the back coat layer. When the surface smoothness of the back coat layer is damaged in such a way, the surface of the magnetic layer which is in contact with the surface of the back coat layer is unfavorably made coarse in the state that the tape is wounded. When the surface smoothness of the magnetic layer is damaged, the electromagnetic conversion property deteriorates.

Furthermore, the back coat layer is also required to have a function of maintaining the shape of the tape so as to make the magnetic layer side shape thereof convex and make the back coat layer side shape thereof concave in any cross section of the tape along the width direction (the so-called cupping property). In order to express the cupping property, curing shrinkage of a binder resin in a coating material for the back coat layer is usually used. When a binder resin which gives a large curing shrinkage, such as nitrocellulose resin, is used, cupping is intensely expressed; thus, it is necessary to make the back coat layer thin to keep the cupping property appropriate. However, it is impermissible merely to make the back coat layer thin as described above.

An object of the present invention is to provide to a high-capacity magnetic recording medium which has a thinned back coat layer excellent in surface smoothness and durability and is excellent in electromagnetic conversion property.

The present inventors have found out that when nitrocellulose resin is used as a binder resin material in a coating material for a back coat layer and further a phosphate amine salt (phosphoric ester amine salt) is incorporated into the coating material for the back coat layer, the cupping property of the back coat layer is appropriately kept and further projections, made of a pigment, on the rear face of anon-magnetic support are concealed, thereby making it possible to improve the surface smoothness and the durability of the back coat layer while making the back coat layer thin.

The present invention comprises the followings:

(1) A magnetic recording medium comprising at least a non-magnetic support, a lower non-magnetic layer on one surface of the non-magnetic support, an upper magnetic layer on the lower non-magnetic layer, and a back coat layer on the other surface of the non-magnetic support,

wherein the lower non-magnetic layer contains at least carbon black, a non-magnetic inorganic powder other than carbon black, and a binder resin material,

the upper magnetic layer contains at least a ferromagnetic powder, and a binder resin material, and

the back coat layer contains at least carbon black, a non-magnetic inorganic powder other than carbon black, a phosphate amine salt, and nitrocellulose resin as a binder resin material, and has a thickness of 0.3 to 0.8 μm.

(2) The magnetic recording medium according to above-described (1), wherein the back coat layer contains 1 to 8 parts by mass of the phosphate amine salt with respect to 100 parts by mass of the total of carbon black and the non-magnetic inorganic powder other than carbon black which constitute the back coat layer.

(3) The magnetic recording medium according to above-described (1) or (2), wherein the phosphate amine salt has a weight-average molecular weight of 10,000 to 50,000.

(4) The magnetic recording medium according to any one of above-described (1) to (3), wherein the phosphate amine salt has an acid value of 10 to 50 KOHmg/g, and an amine value of 10 to 50 KOHmg/g.

(5) The magnetic recording medium according to any one of above-described (1) to (4), wherein the back coat layer contains 50 to 200 parts by mass of nitrocellulose resin with respect to 100 parts by mass of the total of carbon black and the non-magnetic inorganic powder other than carbon black which constitute the back coat layer.

(6) The magnetic recording medium according to any one of above-described (1) to (5), which has a thickness of 4.0 to 7.0 μm.

(7) The magnetic recording medium according to any one of above-described (1) to (6), which has a cupping value of −1.50 mm to −0.10 mm provided that a minus value of the cupping value means that the magnetic layer side of the medium is in a convex form.

According to the present invention, the magnetic recording medium comprises, in the back coat layer, nitrocellulose resin as a binder resin material and a phosphate amine salt (phosphoric ester amine salt). When nitrocellulose resin as the binder resin material is used in a coating material for the back coat layer and further the phosphate amine salt is incorporated into the coating material for the back coat layer, the cupping property of the back coat layer can be appropriately kept and further projections on the rear face of the non-magnetic support can be concealed in the case that the thickness of the back coat layer is set into the range of 0.3 to 0.8 μm. As a result, the surface smoothness and the running durability of the back coat layer can be obtained while the thinning of the back coat layer is attained. Therefore, provided is a magnetic recording medium excellent in electromagnetic conversion property wherein the smoothness of the surface of a magnetic layer which is in contact with the surface of a back coat layer is maintained in the state that the medium is wounded.

### DETAILED DESCRIPTION OF THE INVENTION

The magnetic recording medium of the present invention comprises at least a non-magnetic support, a lower non-magnetic layer on one surface of the non-magnetic support, an upper magnetic layer on the lower non-magnetic layer, and a back coat layer on the other surface of the non-magnetic support. The lower non-magnetic layer has a thickness of, for example, 0.3 to 2.5 μm, the upper magnetic layer has a thickness of, for example, 0.03 to 0.30 μm, and the back coat layer has a thickness of 0.3 to 0.8 μm. The total thickness of the magnetic recording medium is preferably from 4.0 to 7.0 μm. A lubricant coating layer, various coating layers for protecting the magnetic layer, and the like may be formed on the upper magnetic layer if necessary. An undercoat layer (adhesive layer) may be formed on the one surface of the non-magnetic support on which the magnetic layer is to be formed, in order to attain an improvement in the adhesive property between the lower non-magnetic layer and the non-magnetic support, and other effects. In this case, the thickness of the undercoat layer is preferably from 0.05 to 0.30 μm. In order that the adhesive property improvement and the other effects can be expressed, the thickness of the undercoat layer is preferably 0.05 μm or more. When the thickness is 0.05 μm or more and 0.30 μm or less, these effects become sufficient.

In the present invention, the cupping of the tape is expressed mainly by curing shrinkage of nitrocellulose resin in the back coat layer. The degree of the expression of the cupping (the cupping value) is adjusted by the content of nitrocellulose resin in the back coat layer; it should be also considered that the cupping value is adjusted by the balance between the total thickness of the lower non-magnetic layer, the upper magnetic layer and the other optional layer(s) such as the undercoat layer on the one surface of the non-magnetic support and the thickness of the back coat layer on the other surface of the non-magnetic support.

For example, when the back coat layer is made thicker in the case that the total thickness of the lower non-magnetic layer, the upper magnetic layer and the other optional layer(s) such as the undercoat layer is a certain value, the expression of cupping making the magnetic layer side shape convex becomes stronger. On the other hand, when the back coat layer is made thinner, the expression of cupping making the magnetic layer side shape convex becomes weaker. For example, when the total thickness of the lower non-magnetic layer, the upper magnetic layer and the other optional layer(s) such as the undercoat layer is made smaller in the case that the thickness of the back coat layer is a certain value, the expression of cupping making the magnetic layer side shape convex becomes stronger. On the other hand, when the total thickness of the individual layers is made larger, the expression of cupping making the magnetic layer side shape convex becomes weaker.

In design of the magnetic recording medium, it is advisable to consider the adjustment of the thicknesses of the individual layers in order to gain a predetermined cupping value. Out of the lower non-magnetic layer, the upper magnetic layer and the other optional layer(s) such as the undercoat layer, the lower non-magnetic layer has a maximum thickness. In the adjustment of the thicknesses of the individual layers, therefore, it is advisable to make a main consideration of the thickness of the lower non-magnetic layer and that of the back coat layer.

### [Lower Non-Magnetic Layer]

The lower non-magnetic layer comprises at least carbon black, a non-magnetic inorganic powder other than carbon black, and a binder resin material.

The carbon black contained in the lower non-magnetic layer may be furnace black for rubber, thermal black for rubber, black for color, acetylene black or the like. It is preferred that the specific area thereof is from 5 to 600 m²/g, the DBP oil absorption thereof is from 30 to 400 mL/100 g, and the particle diameter thereof is from 10 to 100 nm. For the carbon black which can be used, specifically, “carbon black guide book” edited by the Carbon Black Association of Japan can be referred to.

The amount of the carbon black incorporated into the lower non-magnetic layer is from 5 to 30% by mass, preferably from 10 to 25% by mass of the lower non-magnetic layer.

The non-magnetic inorganic powder other than carbon black, which is contained in the lower non-magnetic layer, is an inorganic powder made of, for example, α-iron oxide (α-Fe₂O₃), α-iron hydroxide (α-FeO(OH)), CaCO₃, titanium oxide, barium sulfate, or α-Al₂O₃. It is preferred that at least one of α-iron oxide and a-iron hydroxide out of these materials is contained in the layer. It is also preferred that α-iron oxide and α-iron hydroxide are each acicular.

The blend ratio by mass of carbon black to the non-magnetic inorganic powder other than carbon black (carbon black/the non-magnetic inorganic powder other than carbon black (mass ratio)) is preferably from 95/5 to 5/95. If the percentage of blended carbon black is less than 5% by mass, a problem about surface electrical resistance may be caused. If the percentage of the blended non-magnetic inorganic powder other than carbon black is less than 5% by mass, the surface smoothness of the lower non-magnetic layer may deteriorate and the mechanical strength thereof may lower. The deterioration in the surface smoothness of the lower non-magnetic layer causes a deterioration in the surface smoothness of the upper magnetic layer.

The binder resin material of the lower non-magnetic layer may be a combination that is appropriately selected from thermoplastic resins, thermosetting or thermoreactive resins, radiation (electron beam or ultraviolet ray) curable resins and other resins in accordance with the property of the medium or conditions for the production process thereof. Of these resins, electron beam curable resins are preferred. More preferred is a combination of electron beam curable vinyl chloride copolymer and polyurethane resin described below.

The vinyl chloride copolymer is preferably one having a vinyl chloride content of 50 to 95% bymass, and is more preferably one having a vinyl chloride content of 55 to 90% by mass. The average degree of polymerization thereof is preferably from about 100 to 500. Particularly, preferable is a copolymer made from vinyl chloride and a monomer having an epoxy (glycidyl) group. The vinyl chloride copolymer is modified to be electron beam sensitive by introducing (meth)acrylic double bonds, or the like, using known techniques.

The polyurethane resin, which is used together with the vinyl chloride resin, is a generic name given to resins obtained by reaction of hydroxy group containing resins, such as polyester polyol and/or polyether polyol, with polyisocyanate-containing compounds. The number-average molecular weight thereof is from about 5,000 to 200,000, and the Q value (i.e., the mass-average molecular weight/the number-average molecular weight) thereof is from about 1.5 to 4. The polyurethane resin is modified to be electron beam sensitive by introducing (meth)acrylic double bonds using known techniques.

Besides the vinyl chloride copolymer and the polyurethane resin, known various resins may be incorporated into the non-magnetic layer at an amount in the range of 20% or less by mass of all the binders in this layer.

In order to improve the crosslinking efficiency of the electron beam curable binder resin used in the present invention, it is preferred to use, as a crosslinking agent, an electron beam curable polyfunctional monomer, preferably a polyfunctional (meth)acrylate.

The polyfunctional (meth)acrylate monomer is not particularly limited, and examples thereof include ethylene glycol di(meth)acrylate, diethylene glycol di(meth)acrylate, polyethylene glycol di(meth)acrylate, 1,6-hexane glycol di(meth)acrylate, pentaerythritol tetra(meth)acrylate, trimethylolpropane tri(meth)acrylate, and trimethylolpropane di(meth)acrylate.

As the polyfunctional (meth)acrylate monomer, diacrylate adducts described in the following can be preferably used:

a diacrylate adduct (IPDI-2HPA) having a structure wherein hydroxypropyl acrylate (HPA) is added to each of two isocyanate groups in isophoronediisocyanate (IPDI) through a hydroxy group, a diacrylate adduct (IPDI-2HEA) having a structure wherein hydroxyethyl acrylate (HEA) is added to each of two isocyanate groups in isophoronediisocyanate (IPDI) through a hydroxy group; and

a diacrylate adduct (TDI-2HPA) having a structure wherein hydroxypropyl acrylate (HPA) is added to each of two isocyanate groups in tolylene 2,4-diisocyanate (TDI) through a hydroxy group.

In order to obtain an improved crosslinking efficiency, it is advisable to use the electron beam curable polyfunctional monomer at an amount of 1 to 50 parts by mass, preferably 5 to 40 parts by mass with respect to 100 parts by mass of the total of the electron beam curable binder resin and the electron beam curable polyfunctional monomer.

The content of the binder resin used in the lower non-magnetic layer is preferably from 10 to 100 parts by mass, more preferably from 12 to 30 parts by mass with respect to 100 parts by mass of the total of the carbon black and the non-magnetic inorganic powder other than the carbon black in the lower non-magnetic layer. If the content of the binder is too small, the ratio of the binder resin in the lower non-magnetic layer lowers so that a sufficient coating film strength cannot be obtained. If the content of the binder is too large, the medium, when being made into a tape, is easily warped along the width direction of the tape. Consequently, the state of contact between the tape and a head tends to get bad.

It is preferred that the lower non-magnetic layer comprises a lubricant if necessary. The lubricant may be saturated or unsaturated, and may be a known lubricant, examples of which include fatty acids such as stearic acid and myristic acid; fatty acid esters such as butyl stearate and butyl palmitate; and sugars. These may be used alone or in a mixture of two or more thereof. It is preferred to use a mixture of two or more fatty acids having different melting points, or a mixture of two or more fatty acid esters having different melting points. This is because it is necessary to supply lubricants adapted to all temperature environments in which the magnetic recording medium is used onto the surface of the medium without interruption.

The lubricant content in the lower non-magnetic layer may be appropriately adjusted in accordance with purpose, and is preferably from 1 to 20% by mass of the total mass of the carbon black and the non-magnetic inorganic powder other than the carbon black in the lower non-magnetic layer.

A coating material for forming the lower non-magnetic layer is prepared by adding an organic solvent to the above-mentioned individual components and subjecting the resultant to mixing, stirring, kneading, dispersing and other treatments in a known manner. The used organic solvent is not limited to any especial kind, and may be appropriately selected from various solvents such as ketone solvents (such as methyl ethyl ketone (MEK), methyl isobutyl ketone, and cyclohexane) and aromatic solvents (such as toluene). These may be used alone or in combination of two or more thereof. The amount of the added organic solvent is set into the range of about 100 to 900 parts by mass with respect to 100 parts by mass of the total of the carbon black, the various inorganic powder(s) other than the carbon black, the binder resin, and polyfunctional monomer.

The thickness of the lower non-magnetic layer is usually from 0.3 to 2.5 μm, preferably from 0.5 to 2.0 μm. If the non-magnetic layer is too thin, the layer is easily affected by the surface roughness of the non-magnetic support so that the surface smoothness of the non-magnetic layer deteriorates and, also, the surface smoothness of the magnetic layer deteriorates easily. Consequently, the electromagnetic conversion property of the magnetic layer tends to deteriorate. Also, too thin a non-magnetic layer leads to an increased light transmittance, causing problems when medium end is detected by the changes in the light transmittance. On the other hand, making a non-magnetic layer thicker than a certain thickness would not correspondingly improve the performance of the magnetic recording medium.

### [Upper Magnetic Layer]

The upper magnetic layer comprises at least a ferromagnetic powder and binder resin materials.

In the present invention, the ferromagnetic powder is preferably a magnetic metal powder or a planar hexagonal fine powder. The magnetic metal powder preferably has a coercive force Hc of 118.5 to 278.5 kA/m (1,500 to 3,500 Oe), a saturation magnetization as of 70 to 160 Am²/kg (emu/g), an average major axis length of 0.03 to 0.1 μm, an average minor axis length of 8 to 20 nm, and an aspect ratio of 1.2 to 20. The Hc of the medium produced by use of the magnetic metal powder is preferably from 118.5 to 278.5 kA/m (1,500 to 3,500 Oe). The planar hexagonal fine powder preferably has a coercive force Hc of 79.6 to 278.5 kA/m (1,000 to 3,500 Oe), a saturation magnetization as of 40 to 70 Am²/kg (emu/g), an average planar particle size of 15 to 80 nm, and a plate ratio of 2 to 7. The Hc of the medium produced by use of the planar hexagonal fine powder is preferably from 94.8 to 318.3 kA/m (1,200 to 4,000 Oe).

It is advisable that the magnetic layer comprises the ferromagnetic powder in an amount of about 70 to 90% by mass of the layer. If the content of the ferromagnetic powder is too large, the content of the binder decreases so that the surface smoothness deteriorates easily by calendering. On the other hand, if the content of the ferromagnetic powder is too small, a high reproducing output cannot be obtained.

The binder resin material for the upper magnetic layer is not particularly limited, and the following may be used: a combination that is appropriately selected from thermoplastic resins, thermosetting or thermoreactive resins, radiation (electron beam or ultraviolet ray) curable resins and other resins in accordance with the property of the medium or conditions for the production process thereof.

The content of the binder resin used in the upper magnetic layer is preferably from 5 to 40 parts by mass, more preferably from 10 to 30 parts by mass with respect to 100 parts by mass of the ferromagnetic powder. If the content of the binder is too small, the strength of the magnetic layer lowers so that the running durability of the medium deteriorates easily. On the other hand, if the content of the binder is too large, the content of the ferromagnetic powder lowers so that the electromagnetic conversion property tends to deteriorate.

The upper magnetic layer further contains an abrasive having a Mohs hardness of 6 or more, such as α-alumina (Mohs hardness: 9), for the purposes of increasing the mechanical strength of the magnetic layer and preventing clogging of the magnetic head. Such an abrasive usually has an indeterminate form, causes the magnetic head to be prevented from clogging, and causes the strength of the coating film to be improved.

The average particle diameter of the abrasive is, for example, from 0.01 to 0.2 μm, preferably from 0.05 to 0.2 μm. If the average particle diameter of the abrasive is too large, then the projections from the surface of the magnetic layer become significant, causing a decrease in the electromagnetic conversion property, an increase in the drop-outs, an increase in the head wear, and the like. If the average particle diameter of the abrasive is too small, then the projections from the surface of the magnetic layer will become small, leading to insufficient prevention of clogged heads.

The average particle diameter is usually measured with a transmission electron microscope. The content of the abrasive may be from 3 to 25 parts by mass, preferably from 5 to 20 parts by mass with respect to 100 parts by mass of the ferromagnetic powder.

If necessary, various additives may be added to the magnetic layer, examples of the additives including dispersants such as a surfactant, and lubricants such as higher fatty acid, fatty acid ester, and silicone oil.

A coating material for forming the upper magnetic layer is prepared by adding an organic solvent to the above-mentioned individual components and subjecting the resultant to mixing, stirring, kneading, dispersing and other treatments in a known manner. The organic solvent to be used is not limited to any especial kind, and may be the same as used in the lower non-magnetic layer.

The thickness of the upper magnetic layer is preferably from 0.03 to 0.30 μm, more preferably from 0.05 to 0.25 μm. If the magnetic layer is too thick, the self-demagnetization loss or thickness loss thereof increases.

The centerline average roughness (Ra) of the upper magnetic layer surface is preferably from 1.0 to 5.0 nm, more preferably from 1.0 to 4.0 nm. If the Ra is less than 1.0 nm, the surface is too smooth so that the running stability deteriorates. As a result, troubles are easily caused during running of the recording medium. On the other hand, if the Ra is more than 5.0 nm, the magnetic layer surface gets rough. As a result, the electromagnetic conversion properties of the magnetic recording medium, such as the reproducing output thereof, deteriorate in a reproducing system using an MR head.

### [Back Coat Layer]

In the present invention, the back coat layer comprises at least carbon black, a non-magnetic inorganic powder other than carbon black, a phosphate amine salt (phosphoric ester amine salt), and nitrocellulose resin as a binder resin material, and has a thickness of 0.3 to 0.8 μm.

The back coat layer is formed to improve the running stability of the recording medium, prevent the electrification of the magnetic layer, or attain some other purpose. Since the surface of the back coat layer is in contact with the surface of the magnetic layer in the state that the tape is wounded, it is necessary to heighten the smoothness of the back coat layer surface and the running durability thereof in order to maintain the smoothness of the magnetic layer surface. The back coat layer is also required to have a function of maintaining the shape of the tape so as to make the magnetic layer side shape thereof convex and make the back coat layer side shape thereof concave in any cross section of the tape along the width direction (the so-called cupping property).

Hitherto, a back coat layer has been formed by applying a back coat layer coating material comprising, for example, carbon black, a non-magnetic inorganic powder other than carbon black, and a binder resin onto the rear surface of a non-magnetic support.

With a rise in the capacity of magnetic recording media in recent years, the smoothing of the front surface of the non-magnetic support, on which a magnetic layer is to be formed, is being advanced in order to improve the smoothness of the surface of the magnetic layer. In the present circumstances, however, projections on the rear surface of the non-magnetic support are caused to remain as in the past in order to maintain stable transportation during coating steps in production of the recording medium.

Accordingly, when a back coat layer is made thin, projections on the rear surface of the non-magnetic support may stick out from the surface of the thinned back coat layer. Alternatively, the projections on the rear surface of the non-magnetic support may make the surface of the thinned back coat layer coarse even if the projections do not stick out from the surface of the back coat layer. When the surface smoothness of the back coat layer, which is formed by coating, deteriorates, surface irregularities of the back coat layer are transferred to the magnetic layer surface in the state that the tape is wounded. Thus, the surface smoothness of the magnetic layer lowers so that the error rate deteriorates. In order to remove this evil, it is necessary in the present invention that the thickness of the back coat layer is set to 0.3 μm or more.

Nitrocellulose resin, which is a thermosetting resin, has a large curing shrinkage degree, so that the coating film of a back coat layer containing the resin will shrink remarkably. As a result, the cupping property tends to be strongly expressed. If the thickness of the back coat layer is set to 0.3 μm or more, the cupping property is expressed too strongly. A tape having such a back coat layer is unsuitable as a magnetic tape. In the case of using nitrocellulose resin as a binder resin material in this manner, it is impossible to make the following compatible with each other: the expression of an appropriate cupping property by the curing shrinkage of a back coat layer and an improvement in the surface smoothness of the back coat layer.

Thus, a phosphate amine salt (phosphoric ester amine salt) is incorporated into a coating material for the back coat layer in the present invention in order to make the following compatible with each other: the expression of an appropriate cupping property by action of the back coat layer and an improvement in the surface smoothness of the back coat layer.

Carbon black contained in the back coat layer may be the same carbon black as described in the item of the lower non-magnetic layer. It is preferred to use, in the back coat layer, both of carbon black having a relatively large particle diameter of 50 to 150 nm and carbon black having a relatively small particle diameter of 13 to 30 nm, in order to attain running stability. In this case, it is advisable to set the ratio by mass of the carbon black having a relatively large particle diameter to the carbon black having a relatively small particle diameter into the range of about 5/95 to 20/80.

The blended amount of carbon black is from 30 to 80% by mass of the back coat layer, preferably from 35 to 70% by mass thereof.

Besides carbon black, various non-magnetic inorganic powders are used in the back coat layer in order to control the mechanical strength. Examples of the inorganic powder include α-Fe₂O₃, CaCO₃, titanium oxide, barium sulfate, or α-Al₂O₃.

The blend ratio by mass of carbon black to the non-magnetic inorganic powder other than carbon black is preferably from 70/30 to 95/5. If the percentage of blended carbon black is less than 70% by mass, the surface electrical resistance of the back coat layer becomes high so that dirt and dust adhere easily to the layer. Moreover, the light transmittance becomes large; thus, when the tape is running on a tape drive, an erroneous operation may be caused in detection of the terminal end of the tape.

In the present invention, nitrocellulose resin is used as a binder resin material in the back coat layer. As described above, nitrocellulose resin has a large curing shrinkage degree, so that a coating film of the back coat layer will shrink remarkably to express a strong cupping property. Moreover, nitrocellulose resin is preferred for making the strength of the back coat layer high to make the running durability high. Furthermore, nitrocellulose resin is preferred for preventing adhesion between the back coat layer surface and the magnetic layer surface in the state that the tape is wounded.

Nitrocellulose used in the present invention is not particularly limited, and may be nitrocellulose produced by any known process. Nitrocellulose is preferably, for example, nitrocellulose having such a polymerization degree that the viscosity prescribed in JIS K-6703 is from about 2 seconds to about 1/16 second. Examples of a commercially available product thereof include BTH-2, BTH-1, BTH-½, BTH-¼, BTH-⅛ and BT-SL (trade names) manufactured by Asahi Kasei Corporation; HIG 2, HIG 1, HIG ½, HIG ¼, HIG ⅛ and HIG 1/16 (trade names) manufactured by SNPE Co. (in France); and RS 2, RS 1, RS ½, RS ¼, RS ⅛ and RS 1/16 (trade names) manufactured by Daicel Chemical Industries, Ltd. The form of nitrocellulose is any form, such as an organic-solvent-containing pellet form, an organic solvent solution form, or an organic-solvent-containing powder form.

The content of nitrocellulose resin used in the back coat layer is preferably from 50 to 200 parts by mass, more preferably from 70 to 150 parts by mass with respect to 100 parts by mass of the total of carbon black and the non-magnetic inorganic powder other than carbon black.

If the content of nitrocellulose resin is too small, the strength of the back coat layer lowers so that the running durability is liable to deteriorate. Moreover, the cupping property is less expressed.

On the other hand, if the content of nitrocellulose resin is too large, the content of carbon black and the non-magnetic inorganic powder other than carbon black declines to give a tendency that the mechanical strength decreases and the light transmittance increases. Additionally, the cupping property tends to be expressed too strongly even if the thickness of the back coat layer is 0.8 μm or less.

In the present invention, any other resin than nitrocellulose resin may be used as another binder resin material in the back coat layer in such an amount that the advantageous effects of the present invention are not damaged. The content of the other resin should be decided in such a manner that the total content of the other resin and nitrocellulose resin is set to 200 parts by mass or less with respect to 100 parts by mass of the total of carbon black and the non-magnetic inorganic powder other than carbon black. The other binder resin material is not particularly limited, and an appropriate combination may be selected for use from thermoplastic resin, thermosetting or thermoreactive resin, radiation (electron beam or ultraviolet ray) curable resin, and other resins in accordance with properties of the medium, and conditions in the production process of the medium. The use of electron beam curable resin is also preferred, and the use of thermosetting resin is also preferred. As the thermosetting resin, polyurethane resin is preferably used.

The phosphate amine salt (phosphoric ester amine salt) used in the back coat layer coating material is generally represented by the formula:

R²¹—OPO₃⁻HN⁺(R²²)(R²³)(R²⁴)

wherein R²¹, R²², R²³ and R²⁴, which may be the same or different, each represent a polymer chain, or a linear or branched alkyl group. Examples of the polymer chain include polyether, polyester and polyether ester.

When the phosphate amine salt is incorporated into the coating material for the back coat layer, the curing shrinkage of nitrocellulose resin is relieved so that the expression of the cupping property is restrained to some extent. For this reason, it becomes possible to form the back coat layer so as to have a thickness of 0.3 to 0.8 μm, which is sufficient for concealing projections on the rear surface of the non-magnetic support. As a result, attained is compatibility of the expression of an appropriate cupping property by action of the back coat layer containing nitrocellulose resin with an improvement in the surface smoothness of the back coat layer.

The reason why the addition of the phosphate amine salt causes relief of the curing shrinkage of nitrocellulose resin in the coating film of the back coat layer would be as follows:

The phosphate amine salt is adsorbed on the surface of carbon black or the non-magnetic inorganic powder other than carbon black, so that the phosphate amine salt is uniformly dispersed in the coating material for the back coat layer. In the coating film of the back coat layer, which is formed by applying the coating material for the back coat layer, also, the phosphate amine salt is uniformly dispersed among molecules of nitrocellulose resin. For this reason, in the curing step of the coating film, curing shrinkage among the nitrocellulose resin molecules would be relieved.

The phosphate amine salt preferably has a weight-average molecular weight of 10,000 to 50,000. In the case that the surface state of particles of carbon black contained in the back coat layer is considered from the area ratio between their polar faces and their nonpolar faces, the nonpolar faces usually occupy almost all. In order that the phosphate amine salt is adsorbed on the surface of carbon black having such nonpolar faces and carbon black on which said salt is adsorbed are dispersed satisfactorily to relieve the curing shrinkage of the coating film, it is suitable to use the phosphate amine salt having a relatively high molecular weight. It is therefore preferred that the phosphate amine salt has the above-mentioned weight-average molecular weight. If the weight-average molecular weight is smaller than 10,000, the polarity of the contained amine salts is intensely expressed, so that the dispersion properties tend to lower. If the weight-average molecular weight is more than 50,000, the polarity of the contained amine salts is conversely expressed with difficulty so that the dispersion properties tend to lower. The phosphate amine salt more preferably has a weight-average molecular weight of 20,000 to 40,000.

The phosphate amine salt preferably has an acid value of 10 to 50 KOHmg/g and an amine value of 10 to 50 KOHmg/g, and more preferably has an acid value and an amine value in these ranges wherein the amine value is larger than the acid value. As described above, about the surface state of the carbon black particles contained in the back coat layer, almost all portions of the surfaces are in a nonpolar state. When polar faces which are slightly present are considered from the area ratio of their acidic faces to their basic faces, the surfaces are in a state that the ratio of the acidic faces to the basic faces is approximately one or slightly higher than one. Accordingly, in order that the phosphate amine salt is adsorbed on the surface of carbon black having such a surface property and carbon black on which said salt is adsorbed are dispersed satisfactorily to relieve the curing shrinkage of the coating film, the phosphate amine salt is preferably a salt wherein the acid value and the amine value balance between each other (that is, a salt having an acid value of 10 to 50 KOHmg/g and an amine value of 10 to 50 KOHmg/g as described above), and is more preferably a salt having an acid value and an amine value in these ranges wherein the amine value is larger than the acid value. The phosphate amine salt more preferably has an acid value of 10 to 30 KOHmg/g and an amine value of 20 to 40 KOHmg/g.

The acid value is an index of the content of a free acid in a material, and is represented by the numerical value of milligrams of potassium hydroxide necessary for neutralizing an acidic group per gram of a (solid) material. As the indicator for measuring this value, phenolphthalein is generally used. The amine value is an index of the content in a free base in a material, and is represented by the value obtained by converting, into the numerical value of milligrams of potassium hydroxide, the mole number of the free base content (amine amount) obtained by making a basic group in one gram of a (solid) material slightly acidic by the addition of an acidic solution (for example, sulfuric acid) having an already-known concentration, neutralizing (back-titrating) the acid group newly with potassium hydroxide, and then making a calculation. As the indicator for measuring the value, phenolphthalein is generally used.

The blend amount of the phosphate amine salt in the back coat layer is preferably from 1 to 8 parts by mass, more preferably from 2 to 6 parts by mass with respect to 100 parts of the total of carbon black and the non-magnetic inorganic powder other than carbon black which constitute the back coat layer. If the amount of the phosphate amine salt is less than 1 part by mass, the adsorbing effect on the surface of carbon black and the dispersing effect of carbon black in the back coat layer coating material are insufficient so that the effect of relieving the curing shrinkage of the coating film is not easily obtained. On the other hand, even if the amount is more than 8 parts by mass, the dispersing effect and the effect of relieving the curing shrinkage of the coating film do not become better.

A specific example of the phosphate amine salt is a product manufactured by Kusumoto Chemicals Ltd. (trade name: DA-325). One kind of the phosphate amine salts may be used, or two or more kinds thereof may be used in combination.

As described above, by using nitrocellulose resin as a binder resin material in the coating material for the back coat layer and further incorporating a phosphate amine salt into the coating material, the dispersibility of the coating material for the back coat layer is maintained and the curing shrinkage of the resultant coating film is relieved to make the expression of the cupping property into an appropriate extent even if carbon black having a relatively large particle diameter and carbon black having a relatively small particle diameter are used together as carbon black species. As a result, the back coat layer can be formed to give a thickness of 0.3 to 0.8 μm, which is sufficient to conceal projections on the rear surface of the non-magnetic support, so as to attain compatibility of the expression of an appropriate cupping property with an improvement in the surface smoothness of the back coat layer.

The coating material for forming the back coat layer is prepared by adding an organic solvent to the above-mentioned individual components and subjecting the resultant to mixing, stirring, kneading, dispersing and other treatments in a known manner. The used organic solvent is not particularly limited, and may be the same solvent as used to form the lower non-magnetic layer.

The thickness of the back coat layer (after the layer is calendared) is from 0.3 to 0.8 μm, preferably from 0.4 to 0.6 μm. If the thickness of the back coat layer is made larger than 0.8 μm, the total thickness of the magnetic recording medium becomes large and further the cupping becomes too intense. Thus, such a thickness should be avoided. Additionally, even if the thickness is made larger than 0.8 μm, the performances are not improved. On the other hand, it is necessary to set the thickness of the back coat layer into 0.3 μm or more in order to conceal projections on the rear surface of the non-magnetic support to give a good surface smoothness as described above.

The centerline average roughness (Ra) of the back coat layer surface is preferably from 5 to 22 nm, more preferably from 5 to 20 nm. If the Ra is less than 5 nm, the surface is too smooth. On the other hand, if the Ra is more than 22 nm, the surface is too rough so that irregularities in the surface are unfavorably transferred onto the surface of the magnetic layer. The centerline ten-point average roughness (Rz) of the back coat layer surface is preferably from 50 to 150 nm, more preferably from 50 to 120 nm.

### [Non-Magnetic Support]

The material used for the non-magnetic support is not particularly limited, and may be selected from various flexible materials, and various rigid materials in accordance with the purpose. The support should be made into a predetermined shape, such as a tape shape, and a predetermined size, in accordance with one out of various standards. Examples of the flexible materials include polyesters such as polyethylene terephthalate (PET) and polyethylene naphthalate (PEN), polyolefins such as polypropylene, and various resins such as polyamide (PA), polyimide (PI), polyamideimide (PAI), and polycarbonate. The non-magnetic support is preferably a film made of a resin selected from PEN, PA, PI, and PAI.

The thickness of the non-magnetic support is preferably from 2.0 to 6.0 μm. The total thickness of the magnetic recording medium is preferably set into the range of 4.0 to 7.0 μm, as will be detailed below; if the thickness of the support is larger than 6.0 μm, the total thickness of the medium may be over 7.0 μm when the design of the individual layers is considered. On the other hand, it is advisable to set the thickness of the non-magnetic support to 2.0 μm or more in order to set the total thickness of the medium to 4.0 μm or more.

### [Production of Magnetic Recording Medium]

In the present invention, prepared coating materials for forming the non-magnetic layer, for forming the magnetic layer, and for forming the back coat layer are used and subjected to applying, drying, calendering, curing and other treatments so as to form respective coating films (coating layers). In this way, a magnetic recording medium is produced.

It is advisable to set the total thickness of the magnetic recording medium into the range of 4.0 to 7.0 μm. If the thickness of the magnetic recording medium is larger than 7.0 μm, the tape length per tape roll cannot be made large so that an increase in the capacity per tape roll is disturbed. On the other hand, the thickness is preferably 4.0 μm or more in order to keep the rigidity of the magnetic recording medium certainly to obtain the running stability of the medium when the medium is running.

In the present invention, it is preferred that the lower non-magnetic layer and the upper magnetic layer are formed in the so-called wet-on-dry coating manner. However, the layers may be formed in the wet-on-wet coating manner. In the case of the wet-on-dry coating manner, a coating material for the non-magnetic layer is first applied onto one surface of a non-magnetic support, and dried, and optionally the resultant is subjected to calendaring treatment, so as to yield an uncured lower non-magnetic layer. Thereafter, the uncured lower non-magnetic layer is cured. In the case of using an electron beam curable resin as the binder resin material of the lower non-magnetic layer, the lower non-magnetic layer is irradiated with an electron beam, so as to be cured. Next, a coating material for the magnetic layer is applied onto the cured lower non-magnetic layer, oriented and dried to form the upper magnetic layer. The timing when the back coat layer is formed may be selected at will. Specifically, the back coat layer may be formed before the formation of the lower non-magnetic layer, after the formation of the lower non-magnetic layer and before that of the upper magnetic layer, or after the formation of the upper magnetic layer.

The method used for applying the above-mentioned coating materials may be any one selected from known various coating methods such as gravure coating, reverse roll coating, die nozzle coating, and bar coating.

### EXAMPLES

The present invention will be more specifically described byway of the following examples. However, the present invention is not limited to only these examples.

### Examples 1-8 and Comparative Examples 1-4

(Preparation of coating material for non-magnetic layer)

| | |
|---|---|
| Non-magnetic powder, Acicular α-Fe₂O₃ | 80.0 parts by mass |
| (average major axis length: 0.1 μm, crystallite size: 12 nm) | |
| Non-magnetic powder, Carbon black | 20.0 parts by mass |
| (trade name: #950B, manufactured by Mitsubishi Chemical Co., | |
| Ltd., average particle diameter: 17 nm, BET specific surface | |
| area: 250 m²/g, DBP oil absorption: 70 mL/100 g, pH: 8) | |
| Electron beam curable binder, Electron beam curable vinyl | 12.0 parts by mass |
| chloride resin | |
| (trade name: TB-0246, manufactured by Toyobo Co., Ltd., (solid | |
| content) vinyl chloride —epoxy containing monomer copolymer, | |
| average degree of polymerization: 310, content of S based on | |
| the use of potassium persulfate: 0.6% by mass, MR110 | |
| (manufactured by Nippon Zeon Corp.) subjected to acrylic | |
| modification with 2-isocyanate ethyl methacrylate (MOI), acryl | |
| content: 6 mol/1 mol) | |
| Electron beam curable binder, Electron beam curable polyurethane | 10.0 parts by mass |
| resin | |
| (trade name: TB-0216, manufactured by Toyobo Co., Ltd., (solid | |
| content) hydroxy-containing acrylic compound —phosphonic acid | |
| group-containing phosphorus compound —hydroxy-containing | |
| polyester polyol, average molecular weight: 13,000, P content: | |
| 0.2% by mass, acryl content: 8 mol/1 mol) | |
| Dispersant, phosphoric acid ester | 1.0 part by mass |
| (trade name: RE-610, manufactured by TOHO Chemical Industry Co., | |
| Ltd.) | |
| Abrasive, α-alumina | 5.0 parts by mass |
| (trade name: HIT60A, manufactured by Sumitomo Chemical Co., Ltd., | |
| average particle diameter: 0.18 μm) | |
| NV (Non-Volatile content) = 33% by mass | |

The above-mentioned materials were subjected to kneading treatment with a kneader. Thereafter, the mixture was dispersed in a lateral type pin mill, filled with zirconia beads of 0.8 mm diameter at a filling rate of 80% (percentage of voids: 50% by volume). Thereafter, to this dispersion were further added the following lubricant materials:

| | |
|---|---|
| 1.0 part by mass of lubricant; | fatty acid |
| | (trade name: NAA180, manufactured by NFO Corp.), |
| 0.5 part by mass of lubricant; | fatty acid amide |
| | (trade name: Fatty Acid AMIDES, manufactured by Kao Corp.), |
| | and |
| 1.5 parts by mass of lubricant; | fatty acid ester |
| | (trade name: NIKKOLBS, manufactured by Nikko Chemicals Co., Ltd.), |
| | and the dispersion was diluted to have a NV (Non-Volatile |
| | content) of 25% by mass and the following solvent ratio by mass: |
| | MEK/toluene/cyclohexanone = 2/2/1. Thereafter, the mixture was |
| | dispersed. Subsequently, the resultant coating material was |
| | filtrated through a filter having an absolute filtration |
| | precision of 3.0 μm to prepare a non-magnetic coating material. |

Next, to the prepared non-magnetic coating material were added 0.2 part by mass of a hardener (COLONATE L, manufactured by Nippon Polyurethane Industry Co., Ltd.), and then they were mixed. Thereafter, the resultant was filtrated through a filter having an absolute filtration precision of 1.0 μm, so as to prepare a coating material for non-magnetic layer used in the present Examples.

(Preparation of coating material for magnetic layer)

| | |
|---|---|
| Ferromagnetic powder, Fe-based acicular ferromagnetic powder | 100.0 parts by mass |
| (Fe/Co/Al/Y = 100/20/3/10 (atomic ratio), Hc: 180 kA/m, σs: 135 Am²/kg, | |
| BET specific surface area: 55 m²/g, average major axis | |
| length: 0.09 μm) | |
| Binder, vinyl chloride copolymer | 10.0 parts by mass |
| (trade name: MR110, manufactured by Nippon Zeon Corp.) | |
| Binder, polyester polyurethane | 6.0 parts by mass |
| (trade name: UR8300, manufactured by Toyobo Co., Ltd.) | |
| Dispersant, phosphoric acid-based surfactant | 3.0 parts by mass |
| (trade name: RE610, manufactured by TOHO Chemical Industry Co., | |
| Ltd.) | |
| Abrasive, α-alumina | 10.0 parts by mass |
| (trade name: HIT60A, manufactured by Sumitomo Chemical Co., Ltd., | |
| average particle diameter: 0.18 μm) | |
| NV (Non-Volatile content) = 30% by mass | |
| Solvent ratio: MEK/toluene/cyclohexanone = 4/4/2 (ratio by mass) | |

The above-mentioned materials were subjected to kneading treatment with a kneader. Thereafter, the mixture was subjected to preparatory dispersion in a lateral type pin mill, filled with zirconia beads of 0.8 mm diameter at a filling rate of 80% (percentage of voids: 50% by volume). Next, the dispersion was diluted so as to have a NV (Non-Volatile content) of 15% by mass and the following solvent ratio by mass: MEK/toluene/cyclohexanone=22.5/22.5/55. The mixture was then subjected to finishing dispersion. Subsequently, immediately before applying, to the resultant coating material were added 10 parts by mass of a hardener (trade name: COLONATE L, manufactured by Nippon Polyurethane Industry Co., Ltd.), and then they were mixed. Thereafter, the mixture was filtrated through a filter having an absolute filtration precision of 1.0 μm to prepare a coating material for magnetic layer.

(Preparation of coating material for back coat layer)

| | |
|---|---|
| Carbon black | 75 parts by mass |
| (trade name: BP-880, manufactured by Cabot Corp., average | |
| particle diameter: 17 nm, BET specific surface area: 210 m²/g) | |
| Carbon black | 10 parts by mass |
| (trade name: BP-130, manufactured by Cabot Corp., average | |
| particle diameter: 75 nm, DBP oil absorption: 69 mL/100 g, BET | |
| specific surface area: 25 m²/g) | |
| Barium sulfate | 15 parts by mass |
| (trade name: BARIFINE BF-20, manufactured by Sakai Chemical | |
| Industry Co., Ltd., average particle diameter: 30 nm) | |
| Nitrocellulose | 50 parts by mass |
| (trade name: BTH1/2, manufactured by Asahi Kasei Corp.) | |
| Polyurethane resin | 40 parts by mass |
| (trade name: UR-8300, manufactured by Toyobo Co., Ltd., | |
| containing sodium sulfonate) | |
| Dispersant: Carboxylic acid amine salt | 8 parts by mass |
| (trade name: DA-7300, manufactured by Kusumoto Chemicals Ltd.) | |
| Phosphate amine salt | part by mass shown in Table 1 |
| (trade name: DA-325, manufactured by Kusumoto Chemicals Ltd.) | |
| Methyl ethyl ketone (MEK) | 200 parts by mass |
| Toluene | 200 parts by mass |
| Cyclohexanone | 170 parts by mass |

The above-mentioned phosphate amine salt:
trade name: DA-325, manufactured by Kusumoto Chemicals Ltd.,
acid value: 14 KOHmg/g, amine value: 20 KOHmg/g, weight-average
molecular weight: 20,000 to 35,000

In each of Examples 1 to 8 and Comparative Examples 1 to 4, the above-mentioned phosphate amine salt DA-325 was added parts by mass shown in Table 1.

Each of the above-mentioned compositions was sufficiently kneaded by means of a kneader, and then the composition was dispersed in a sand grinding mill for 5 hours. Thereafter, materials described below were incorporated into the composition, and further the resultant was dispersed for 1 hour.

| | |
|---|---|
| Methyl ethyl ketone | 350 parts by mass |
| Toluene | 350 parts by mass |
| Cyclohexanone | 100 parts by mass |

In the above-mentioned way, each back coat layer coating material (I) was prepared.

To the prepared back coat layer coating material (I) were added 15 parts by mass of a heat-hardener (trade name: COLONATE L, manufactured by Nippon Polyurethane Industry Co., Ltd.) immediately before the coating material was applied. The components were mixed, and the resultant coating material was further filtrated through a filter having an absolute filtration precision of 1.0 μm, so as to yield a final back coat layer coating material used in each of Examples 1 to 8 and Comparative Examples 1 to 4.

### (Non-Magnetic Layer Forming Step)

A dual layer and transverse direction tensilized base film made of PEN, of 5.0 μm in thickness, was used. About each surface of this PEN film, the centerline average roughness (Ra) and the centerline ten-point average roughness (Rz) thereof were as follows:
The magnetic layer side surface on which the non-magnetic layer and the magnetic layer are to be formed:

Ra: 5.0 nm, Rz: 80 nm
The back coat layer side surface on which the back coat layer is to be formed:

Ra: 10.0 nm, Rz: 200 nm

The coating material for non-magnetic layer was applied onto the above-mentioned magnetic layer side surface of the PEN base film by extrusion coating method using a nozzle, so as to make the thickness of the applied coating layer after the following calendering into 1.0 μm. The coating layer was dried, and subsequently the resultant layer was calendered with a calender composed of combinations of a plastic roll with a metal roll under the following conditions: the nip number: 4, working temperature: 100° C., linear pressure: 3,500 N/cm, and velocity: 150 m/min. Furthermore, the resultant was irradiated with electron beams at a dose of 4.0 Mrad, so as to form a non-magnetic layer.

### (Magnetic Layer Forming Step)

The coating material for magnetic layer was applied from a nozzle onto the non-magnetic layer formed as described above so as to make the thickness of the applied coating layer after the following calendering into 0.10 μm. The coating layer was oriented and dried, and subsequently the resultant layer was calendered with a calender composed of combinations of a plastic roll with a metal roll under the following conditions: the nip number: 4, working temperature: 100° C., linear pressure: 3,500 N/cm, and velocity: 150 m/min, so as to form a magnetic layer.

### (Back Coat Layer Forming Step)

Each coating material for back coat layer was applied from a nozzle onto the above-mentioned back coat layer side surface of the PEN base film so as to make the thickness of the applied coating layer after the following calendaring into each thickness value shown in Table 1. The coating layer was dried, and subsequently the resultant layer was calendered with a calender composed of combinations of a plastic roll with a metal roll under the following conditions: the nip number: 4, working temperature: 90° C., linear pressure: 2,100 N/cm, and velocity: 150 m/min, so as to form a back coat layer.

The PEN base film experienced the finishing of the above-mentioned successive treatments was wounded around a wind-up roll, and then the base film was allowed to stand still in a rolled state for 24 hours. Thereafter, the base film was subjected to thermal curing treatment at 60° C. for 48 hours. Next, the resultant was slit into a width of ½ inch (=12.650mm), thereby producing a magnetic tape sample as each of Examples 1 to 8 and Comparative Examples 1 to 4.

### [Evaluation of the Magnetic Tapes]

About each of the magnetic tape samples of Examples 1 to 8 and Comparative Examples 1 to 4, evaluating tests were made on the back coat layer surface roughness, the cupping value, and the error rate in accordance with each method described below.

### (Measurement of the Back Coat Layer Surface Roughness)

The surface roughnesses Ra (nm) and Rz (nm) of each of the back coat layers were measured in accordance with JIS B 0601-1994.

Talystep manufactured by Talar-Hobson was used, and a cutoff filter was used to make the measurement in the range of 3.3 to 167 μm.

### (Measurement of the Cupping Value of the Magnetic Tape)

The ½-inch width tapes were each cut into a length of 2 m. One end of the cut tape was fixed, and the other end was hung in the vertical direction at a room temperature. In this state, the tape was allowed to stand still for 24 hours. Thereafter, a piece 50 cm in length was taken out from a substantially central area in the 2-m length tape piece, and the resultant was put on a horizontal stand to direct the convex surface of the tape upward. An optical microscope was used to measure, with a precision of a focal shift distance of 0.01 mm, the height of the apex of the tape convex surface from the surface of the horizontal stand at each of freely-selected 5 points along the length direction of the 50-cm length tape piece.

At this time, the height of the apex of the tape convex surface from the surface of the horizontal stand was interpreted as a minus value in the case that the magnetic layer surface side of the tape piece had a convex surface. Conversely, the height of the apex of the tape convex surface from the surface of the horizontal stand was interpreted as a plus value in the case that the back coat layer side of the tape piece had a convex surface. From the resultant measured values at the five points, the maximum value and the minimum value were removed, and then the average of the values of the other three points was calculated. The obtained average was defined as the cupping value of the magnetic tape.

It is preferred that the cupping value is a minus value (less than 0.00 mm), that is, the magnetic layer side of the tape is in a convex form. The cupping value is more preferably from −1.50 mm to −0.10 mm, even more preferably from −1.20 mm to −0.20 mm.

### (Measurement of the Error Rate of the Magnetic Tape)

About each of the magnetic tape samples integrated into a cartridge, the error rate thereof was measured by means of a drive manufactured by Hewlett Packard (product name: Ultrium 460 e).

In the measurement, an SCSI control software was used to record about 8 Gbit of random data from beginning of data area of the tape, and then read the data. At this time, the number of correctable C1 errors extracted through the SCSI software was converted into the number of bits. The rate of the number of the C1 error bits to the total number of the written bits was used as the error rate.

The results are shown in Table 1.

### Comprehensive evaluation in Table 1

AA: very good

A: good

B: not good

From Table 1, it was understood that each of the magnetic tape samples produced in Examples 1 to 8 was excellent in the surface smoothness of its back coat layer and in the cupping property of the tapes. Accordingly, in particular, about the magnetic tape sample of each of Examples 3 to 6, the error rate was 5.0×10⁻⁸, which was a very good result. The other error rates were as follows: 2.0×10⁻⁷ (Example 1), 1.3×10⁻⁷ (Example 2), 2.0×10⁻⁷ (Example 7), and 1.3×10⁻⁷ (Example 8).

In Comparative Examples 1 and 2, the thickness of each of their back coat layers was small, so that projections on the rear surface of their PEN base films were unable to be sufficiently concealed. Each of the magnetic tape samples was poor in the surface smoothness of the back coat layer. Accordingly, the error rates were poor in Comparative Examples 1 and 2 and were 5.0×10⁻⁶ and 1.0×10⁻⁶, respectively.

In Comparative Examples 3 and 4, no phosphate amine salt was used so that the cupping value was too large even if the thickness of the back coat layer was as small as 0.3 ρm. Thus, each of the magnetic tape samples became unstable in contact with the magnetic head when the sample was running. For this reason, the error rates were poor in Comparative Examples 3 and 4 and were 5.0×10⁻⁶ and 5.0×10⁻⁵, respectively.

TABLE 1

| | Back coat | | | | | | | |
|---|---|---|---|---|---|---|---|---|
| | coating | | | | | | | |
| | material | | | | | | | |
| | Phosphate | | | | | | | |
| | amine salt | | | | | | | |
| | DA-325 | | | | | | | |
| | Amount of | Magnetic tape sample | | | | | | |
| | addition | Back coat layer | | | Total | Cupping | Error | |
| | part | Thickness | Ra | Rz | Thickness | value | rate | Comprehensive |
| | by mass | μm | nm | nm | μm | mm | bER | evaluation |
| Example 1 | 1 | 0.3 | 18 | 130 | 6.4 | −0.55 | 2.0 × 10⁻⁷ | A |
| Example 2 | 8 | 0.3 | 18 | 130 | 6.4 | −0.10 | 1.3 × 10⁻⁷ | A |
| Example 3 | 2 | 0.4 | 15 | 115 | 6.5 | −0.70 | 5.0 × 10⁻⁸ | AA |
| Example 4 | 6 | 0.4 | 15 | 115 | 6.5 | −0.55 | 5.0 × 10⁻⁸ | AA |
| Example 5 | 2 | 0.6 | 14 | 110 | 6.7 | −1.05 | 5.0 × 10⁻⁸ | AA |
| Example 6 | 6 | 0.6 | 14 | 110 | 6.7 | −0.85 | 5.0 × 10⁻⁸ | AA |
| Example 7 | 1 | 0.8 | 14 | 110 | 6.9 | −1.50 | 2.0 × 10⁻⁷ | A |
| Example 8 | 8 | 0.8 | 14 | 110 | 6.9 | −0.90 | 1.3 × 10⁻⁷ | A |
| Comparative | 1 | 0.25 | 25 | 200 | 6.35 | −0.40 | 5.0 × 10⁻⁶ | B |
| Example 1 | | | | | | | | |
| Comparative | 8 | 0.25 | 25 | 200 | 6.35 | −0.10 | 1.0 × 10⁻⁶ | B |
| Example 2 | | | | | | | | |
| Comparative | — | 0.3 | 20 | 150 | 6.4 | −1.70 | 5.0 × 10⁻⁶ | B |
| Example 3 | | | | | | | | |
| Comparative | — | 0.8 | 15 | 115 | 6.9 | −3.00 | 5.0 × 10⁻⁵ | B |
| Example 4 | | | | | | | | |

What is claimed is:

1. A magnetic recording medium comprising at least a non-magnetic support, a lower non-magnetic layer on one surface of the non-magnetic support, an upper magnetic layer on the lower non-magnetic layer, and a back coat layer on the other surface of the non-magnetic support,
wherein the lower non-magnetic layer contains at least carbon black, a non-magnetic inorganic powder other than carbon black, and a binder resin material,
the upper magnetic layer contains at least a ferromagnetic powder, and a binder resin material, and
the back coat layer contains at least carbon black, a non-magnetic inorganic powder other than carbon black, a phosphate amine salt, and nitrocellulose resin as a binder resin material, and has a thickness of 0.3 to 0.8 μm.

2. The magnetic recording medium according to claim 1, wherein the back coat layer contains 1 to 8 parts by mass of the phosphate amine salt with respect to 100 parts by mass of the total of carbon black and the non-magnetic inorganic powder other than carbon black which constitute the back coat layer.

3. The magnetic recording medium according to claim 1, wherein the phosphate amine salt has a weight-average molecular weight of 10,000 to 50,000.

4. The magnetic recording medium according to claim 1, wherein the phosphate amine salt has an acid value of 10 to 50 KOHmg/g, and an amine value of 10 to 50 KOHmg/g.

5. The magnetic recording medium according to claim 1, wherein the back coat layer contains 50 to 200 parts by mass of nitrocellulose resin with respect to 100 parts by mass of the total of carbon black and the non-magnetic inorganic powder other than carbon black which constitute the back coat layer.

6. The magnetic recording medium according to claim 1, which has a thickness of 4.0 to 7.0 μm.

7. The magnetic recording medium according to claim 1, which has a cupping value of −1.50 mm to −0.10 mm provided that a minus value of the cupping value means that the magnetic layer side of the medium is in a convex form.
